(19) United States
(12) Patent Application Publication
(10) Pub. No.: US 2007/0044917 A1
(43) Pub. Date: Mar. 1, 2007

(54) Plastic Container with In-Mold Label and Method for Manufacturing the Same

(76) Inventor: Yixin Jiang, Dongguan City, Guangdong Province (CN)

Correspondence Address: GLOBAL IP SERVICES, 2462 ROCK ST., APT. 6, MOUNTAIN VIEW, CA, 94043, US

(21) Appl. No.: 11/426,400

(22) Filed: Jun. 26, 2006

(30) Foreign Application Priority Data
Aug. 25, 2005 (CN) 200510036691.1

(51) Int. Cl. B29C 65/00

(52) U.S. Cl. 156/349; 264/328.1

(57) ABSTRACT

A plastic container with in-mold label has an ultra-thin plastic container body and an in-mold label configured corresponding to an outline of the ultra-thin plastic container body. The label has two opposite jagged edges. The label is fusion welded on a periphery of the ultra-thin plastic container body with the jagged edges joggling with each other. A method for manufacturing the plastic container includes: (1) forming an ultra-thin plastic container body by plastic injection molding; (2) providing an in-mold label and spreading the label; (3) cutting two opposite edges to be jointed of the label into jagged edges; (4) fusion welding the label on a periphery of the ultra-thin plastic container body with the jagged edges joggling with each other. The jagged joint is capable of dispersing stress, thereby preventing the plastic container from cracking.

### CROSS REFERENCE TO THE RELATED PATENT APPLICATIONS

This application claims the priority benefit of a Chinese patent application No. 200510036691.1 filed on Aug. 25, 2005.

### BACKGROUND OF THE INVENTION

1. Field of the Invention

The present invention relates to a plastic container with in-mold label and a method for manufacturing the same, and more particularly to a plastic container with in-mold label which has particularly structured joint edges that joggle with each other and a method for manufacturing the same.

2. The Related Art

A plastic container with in-mold label generally comprises a container body formed by injection molding and an in-mold label fusion welded on a periphery of the container body. Two opposite edges of the in-mold label are butt jointed so that the in-mold label encircles the container body. However, the joint edges of conventional in-mold labels are straight. When the conventional in-mold label is fusion welded on the container body, the container body creates a stress concentration zone corresponding to the straight joint of the in-mold label. Once fallen off, the plastic container is prone to crack at the stress concentration zone.

### SUMMARY OF THE INVENTION

Accordingly, an object of the present invention is to provide a plastic container with in-mold label which has jagged joint edges that joggle with each other. The jagged joint is capable of dispersing stress, thereby preventing the plastic container from cracking.

Another object of the present invention is to provide a method for manufacturing the plastic container with in-mold label.

To achieve the above object, a plastic container with in-mold label in accordance with the present invention comprises an ultra-thin plastic container body and an in-mold label configured corresponding to an outline of the ultra-thin plastic container body. The in-mold label has two opposite jagged edges. The in-mold label is fusion welded on a periphery of the ultra-thin plastic container body with the two opposite jagged edges joggling with each other.

To achieve the above object, a method for manufacturing the plastic container with in-mold label in accordance with the present invention comprises the steps of:
(1) forming an ultra-thin plastic container body by plastic injection molding;
(2) providing an in-mold label and spreading the in-mold label into a shape corresponding to an outline of the ultra-thin plastic container body;
(3) cutting two opposite edges to be jointed of the in-mold label into jagged edges; and
(4) fusion welding the in-mold label on a periphery of the ultra-thin plastic container body with the two opposite jagged edges joggling with each other.

Preferably, the in-mold label in step (2) is shaped into sector after spread.

Preferably, the plastic container body is a plastic cup.

A jagged joint is formed as two opposite jagged edges of the in-mold label joggling with each other. The jagged joint is able to effectively disperse stress from different angle and direction that is created during the in-mold label and the ultra-thin plastic container body are fusion welded. Therefore, the ultra-thin plastic container body has no stress concentration zone, and the plastic container is not easy to crack.

### BRIEF DESCRIPTION OF THE DRAWINGS

The present invention will be apparent to those skilled in the art by reading the following description of a preferred embodiment thereof, with reference to the attached drawings, in which:

FIG. 1 is an exploded perspective view of a plastic container with in-mold label in accordance with the present invention;

FIG. 2 is a perspective view of the plastic container with in-mold label;

FIG. 3 is a schematic view of the in-mold label after spread; and

FIG. 4 is a partially enlarged view of the encircled portion labeled IV of FIG. 3, and illustrating its stress analysis.

### DETAILED DESCRIPTION OF THE PREFERRED EMBODIMENT

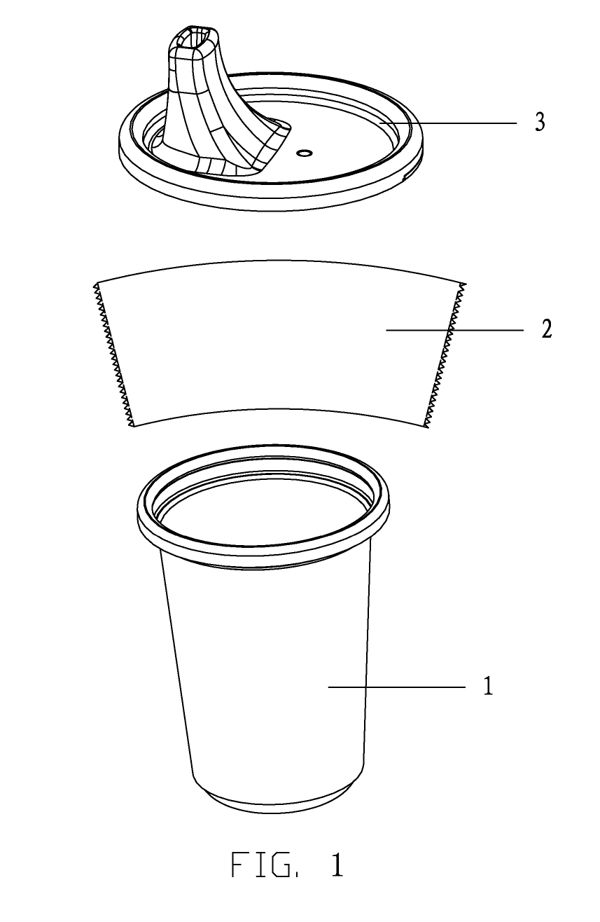

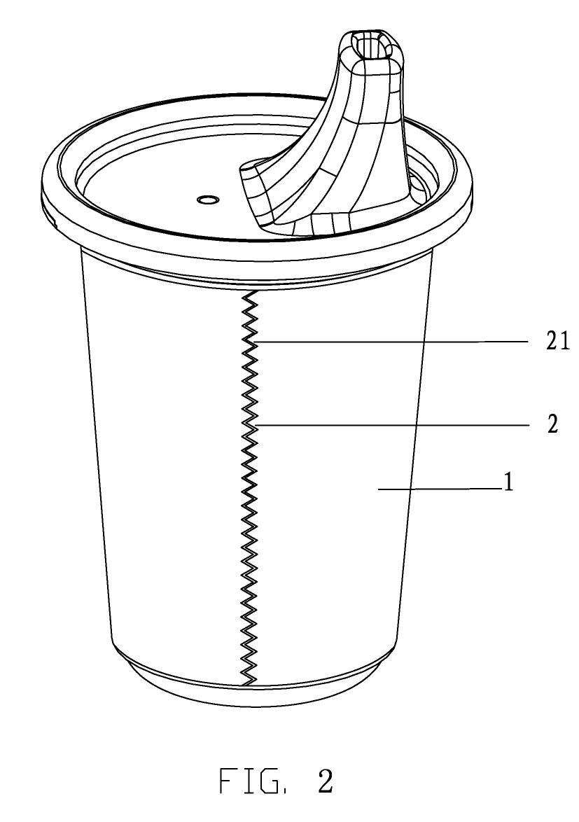

Referring now to FIGS. 1 and 2, a plastic container with in-mold label in accordance with the present invention is shown. The plastic container with in-mold label comprises an ultra-thin plastic container body and an in-mold label 2. In the present embodiment, the plastic container body is a plastic cup which has a plastic cup body 1 and a cup lid 3 covered on an opening of the plastic cup body 1. The in-mold label 2 is configured corresponding to an outline of the plastic cup body. Preferably, the in-mold label 2 is shaped into sector after spread. The in-mold label 2 is fusion welded on a periphery of the plastic cup body 1. After fusion welding, two opposite edges of the in-mold label 2 are butt jointed. The joint edges of the in-mold label 2 are particularly structured to make the joint edges joggle with each other. Preferably, the joint edges are cut into jagged edges. Teeth of the jagged edges can be any angle as long as the jagged edges can joggle with each other. With such structure, the joint edges of the in-mold label form a jagged joint 21.

a method for manufacturing the plastic container with in-mold label in accordance with the present invention comprises the steps of:
(1) forming an ultra-thin plastic container body by plastic injection molding, preferably, forming a plastic cup body 1 and a cup lid 3;
(2) providing an in-mold label 2 and spreading the in-mold label 2 into a shape corresponding to an outline of the ultra-thin plastic container body, preferably, providing the in-mold label 2 with a shape of sector after spread;
(3) cutting two opposite edges to be jointed of the in-mold label 3 into jagged edges; and
(4) fusion welding the in-mold label 3 on a periphery of the ultra-thin plastic container body or the plastic cup body 2 with the two opposite jagged edges joggling with each other.

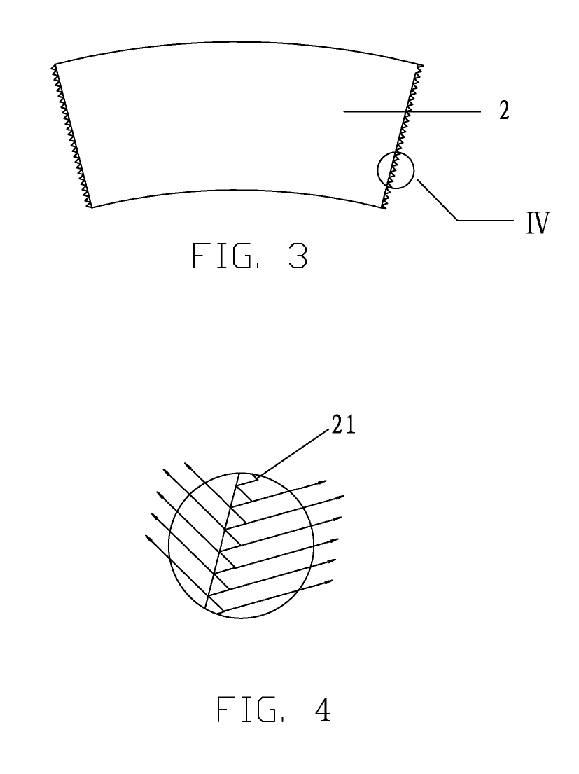

Referring to FIGS. 3 and 4, as illustrated, the jagged joint is able to effectively disperse stress from different angle and direction that is created during the in-mold label 2 and the plastic cup body 1 are fusion welded. Therefore, the plastic cup body 1 has no stress concentration zone, and the plastic container is not easy to crack. Once fallen off, the plastic container is prevented from cracking.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A plastic container with in-mold label comprising:
an ultra-thin plastic container body; and
an in-mold label configured corresponding to an outline of said ultra-thin plastic container body, the in-mold label having two opposite jagged edges, the in-mold label being fusion welded on a periphery of said ultra-thin plastic container body with said two opposite jagged edges joggling with each other.

2. A method for manufacturing a plastic container with in-mold label, the method comprising the steps of:
(1) forming an ultra-thin plastic container body by plastic injection molding;
(2)providing an in-mold label and spreading the in-mold label into a shape corresponding to an outline of said ultra-thin plastic container body;
(3) cutting two opposite edges to be jointed of said in-mold label into jagged edges; and
(4) fusion welding said in-mold label on a periphery of said ultra-thin plastic container body with said two opposite jagged edges joggling with each other.

3. The method according to claim 2, wherein the in-mold label in step (2) is shaped into sector after spread.

4. The method according to claim 2, wherein the plastic container body is a plastic cup.
